(19) United States
(12) Patent Application Publication
(10) Pub. No.: US 2011/0040555 A1
(43) Pub. Date: Feb. 17, 2011

(54) System and method for creating and playing timed, artistic multimedia representations of typed, spoken, or loaded narratives, theatrical scripts, dialogues, lyrics, or other linguistic texts

(76) Inventors: Peter Jürgen Wegner, Gilbert, AZ (US); Kristen M. Wegner, Cornish, NH (US)

Correspondence Address: Peter J. Wegner, 186 Dodge Road, Cornish, NH, 03745, US

(21) Appl. No.: 12/804,109

(22) Filed: Jul. 13, 2010

Related U.S. Application Data
(60) Provisional application No. 61/271,392, filed on Jul. 21, 2009.

(51) Int. Cl. G06F 17/27; G10L 15/18

(52) U.S. Cl. 704/9; 704/E15.018

(57) ABSTRACT

A system and method generate artistic multimedia representations of user-input texts, spoken or loaded narratives, theatrical scripts, or other linguistic corpus types, via a user interface, or batch interface, by classifying component words, and/or phrases into lexemes and/or parts of speech, and interpreting said classifications to construct playable structures. A database of natural language grammatical rules, a set of media objects, parameters, and rendering directives, and an algorithm facilitate the generation of sequential scenes from grammatical representations, convert user-input texts into playable structures of graphics, sounds, animations, and modifications, where playable structures may be combined to create a scene, or multiple scenes, and may be played in the order of occurrence in the input text as a sequential and timed multimedia representation of the input, and subsequently output, in real-time, or stored in memory for later output, via output devices such as a monitor and/or speakers.

### BACKGROUND

Possible Uses of the Invention.

Artistic multimedia representations of compositions and/or narratives may be used for education, communication, security, surveillance, entertainment, and artistic purposes.

Users may use artistic multimedia representations of text and compositions and/or narratives to understand how words and concepts in textual compositions work together, or in related contexts.

Artistic multimedia representations of compositions, and/or narratives may be used as a visual and audible reward for users and language learners with graphics, movements, and sounds for their writing, speaking, and/or singing.

Artistic multimedia representations of compositions and/or narratives may influence writers, speakers, or singers to add more detail, or be more descriptive in their compositions since word choice would be imperative to the resulting multimedia representation.

Artistic multimedia representations of composition and/or narratives may form a new media type for representation of writing, or speaking and singing in art, entertainment, and other fields.

Artistic multimedia representations of scripts or dialogue forms of compositions may be used to understand timing and relations of subjects in said scripts or dialogues.

Artistic multimedia representations of compositions and/or narratives may be used as an educational tool for language-learning by both children and second-language learners.

One possible embodiment of the system and method may be used by the security field to visualize communications. Artistic multimedia representations of textual compositions could be used to create a more understandable visualization of bodies of text input from spoken or written surveillance communications.

### SUMMARY

A system and method are used to convert a typed, spoken, or loaded narrative, script, dialogue, or other types of texts, henceforth referred to as the composition, into a timed, and playable, artistic multimedia representation of said composition, and the resulting artistic multimedia representation is then output to a graphical and/or audio user interface and/or other user interfaces.

The composition passes through a system on a computer or computerized device which uses a method and algorithm to parse and assign words and/or word-pairs and/or phrases into parts of speech.

Upon entry into the system, via a typing input graphical interface box, a file loading selection dialogue, an automatic speech recognition (ASR) system, or any other convenient means of acquiring textual input from a user, each composition is parsed into paragraphs, sentences, and individual words. For each sentence and/or paragraph in the composition, individual words, word pairs, and/or phrases are categorized according to identifiable lexemes. An algorithm then uses lexeme references to assign words, word pairs, and/or phrases to playable structures.

Playable structures include a minimum of a subject (noun) and action (verb), but may also include adjectives, adverbs, and other connecting words that modify or add to the components of the playable structure. Words and word-pairs in individual sentences and/or paragraphs are used to define a scene.

Scenes are comprised of single or multiple playable structures derived from the referencing of individual words and/or word pairs and/or phrases in sentences and/or paragraphs. Scenes may include motion, animation, graphics, sounds, colorization, velocity, direction, and/or locational modifications of said motions, animations and/or graphics, and other media, and are presented to the user via a graphical user interface and audio interface. Multiple playable structures in scenes are connected to each other using a connector. Multiple scenes, or a single scene, in a timed sequence, create a multimedia version of the composition.

A timed series of scenes, or individual scene, that represents the composition then plays back, from start to finish, to the user via a user interface and/or other devices and steps through the multimedia representation of the composition or narrative in a timed manner.

Random numbers, generated by a random number generator, may be used to modify the timing and playable structure, and connector components to produce a natural look and feel to the playback of the composition's multimedia representation.

### DESCRIPTIONS OF THE FIGURES AND APPENDIX

FIG. 1: A flow chart of the input and tokenization steps in the system and method. In step 1, labeled (1), the user types, speaks, sings or loads text. In step 2 (2), text is parsed into paragraphs, sentences and words, in sequence.

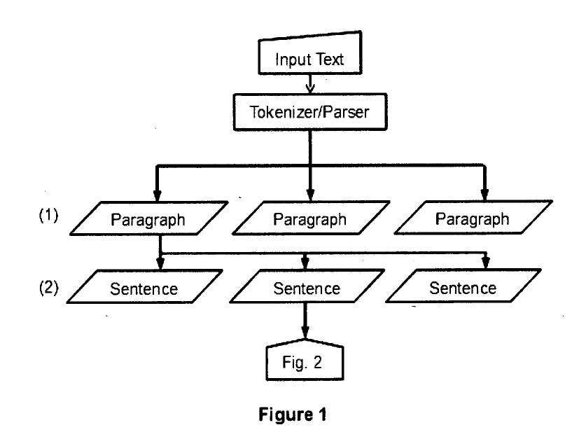

FIG. 2: A flow chart of the creation of playable structure(s) steps in the system and method. In step 3, labeled (3), each word and/or word-pair and/or phrase is referenced to the word database for word/word pair/phrase's data structure.

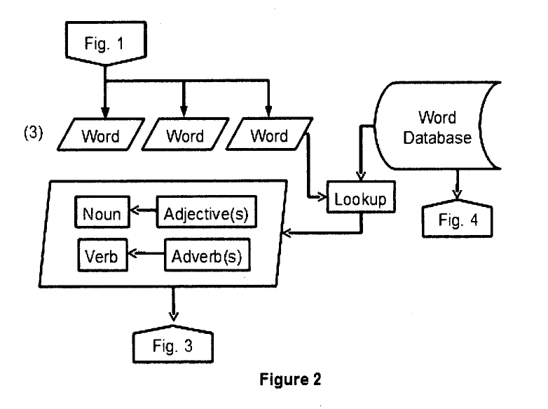

FIG. 3: A flow chart of the building of scene(s) steps in the system and method. In step 4, labeled (4), the algorithm analyzes word types and assigns words, word-pairs, and/or phrases to playable structures.

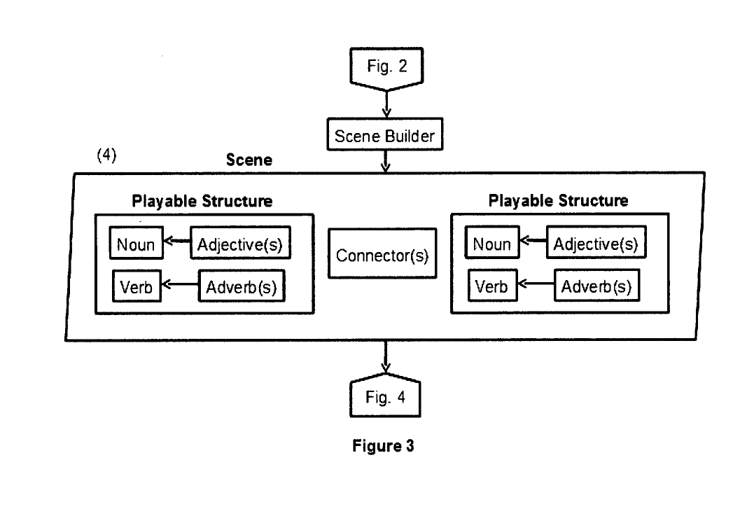

FIG. 4: A flow chart of the output steps in the system and method. In step 5, labeled (5), the algorithm assigns all playable structures to scene(s) and assigns any relationships between playable structures. Nouns and actions are modified by adjectives. In step 6, labeled (6), scene components are referenced to word database and each word, word pair, and/or phrase's information is copied to playable structure. In step 7, labeled (7), the scene is output to user interface and/or speakers, or other device for determined time using playable structure information and relationships. Next scene, if any, is ready to play after end of previous scene.

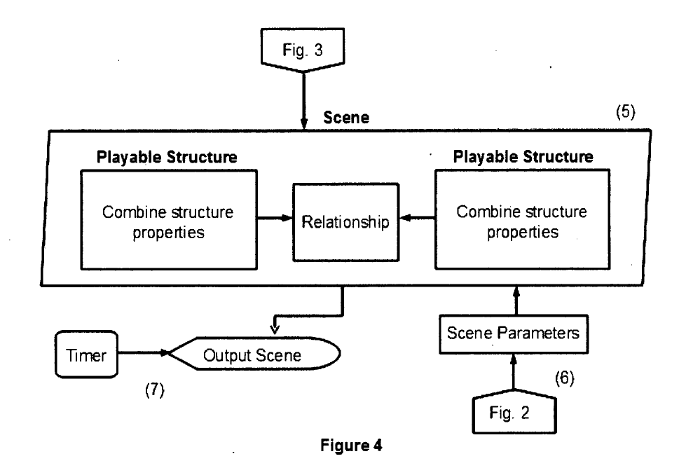

Appendix 1: A pseudo-code of an algorithm for the system and method through which the artistic multimedia representation of the text or composition may be created. The appendix includes the following: functions “process”, “parse”, and “partition”.

Appendix 1. Pseudo-Code

The following algorithms present a feasible and proven approach to converting natural language text into a render-able (playable) artistic multimedia representation, and while not a preferred embodiment, exhibit how it may be approached using current computer programming techniques, and are included here for reference purposes only.

1. Algorithm Pseudocode Listing Function “Process”.

```
  1. function Process(text: string):
ListOfListOfRenderableItems
  2. begin
  3. listOfGrammarData: ListOfGrammarData := Parse(text)
  4. listOfAssociatedElements: ListOfAssociatedElements :=
  Partition(listOfGrammarData)
  5. Connect(listOfAssociatedElements)
  6. Resolve(listOfAssociatedElements)
  7. renderableIndex := 0
  8. result: ListOfListOfRenderableItems :=
ListOfListOfRenderableItems.Create
  9. m: Integer := listOfAssociatedElements.Count
  10. i: Integer := 0
  11. while ((i < m)) do
  12. begin
  13. subListOfAssociations: AssociatedElements :=
listOfAssociatedElements.Item[i]
  14. sentence: ListOfRenderableItems :=
ListOfRenderableItems.Create
```

| | |
|---|---|
| 15. n: | Integer := subListOfAssociations.Count |
| 16. j: | Integer := 0 |

```
  17. while ((j < n)) do
  18. begin
  19. association := subListOfAssociations.Item[j]
  20. sentence.Add(Renderable.Create(renderableIndex,
association.Compact,
  21. listOfGrammarData.Item[i],
association.Words))
  22. inc(renderableIndex)
  23. inc(j)
  24. end
  25. sentence.Sort
  26. result.Add(sentence)
  27. inc(i)
  28. end
  29. end;
```

A. The function “Process” declared here, beginning in line (1) represents the main entry into the text parsing, and grammar to renderable mapping logic algorithm.

B. The result data structure of the function “Process,” “ListOfListOfRenderableItems,” represents a multidimensional, sequential collection of renderable structures that each contain an agglomeration of media elements intended to be rendered together within a similar time span, that are, as a renderable scene or set of scenes, intended to be a multimedia representation of the natural language composition input to the function (the string variable, “text”).

C. The function “Parse” listed in line (3) is detailed in the algorithm pseudocode listing #2 for the function named “Parse.” See below.

D. The data structure “ListOfAssociatedElements” in line (4) represents a collection of associations between words and/or grammatical elements, and media elements that are iteratively accumulated through various database searches, grammatical rules, defaults, scripting logic, procedural concatenations, and other processes.

E. The function “Connect” in line (5) operates on non-associated word and/or media elements, and, utilizing connector word logic, creates animation or other associations between media elements, for example, the statement “X goes to Y” creates a linkage between X and Y.

F. The function “Resolve” in line (6) performs various forward, backward, and nonlinear searches across the list of associations in order to resolve grammatical lacunae, for instance, in the following example: “The elephant is big. I am scared of it. It is running after me.” The subject “The elephant” is stated in the first sentence, yet there is a reference to it in the third sentence, for which we must make a backward reference to find out what is “running after me.” The function “Resolve” solves these kind of problems in running backward searches, in which case the implicit structure becomes: “The elephant is big. I am scared of [the elephant]. [The elephant] is running after me.”

G. The final operation of “Process” is to finalize all renderable structures and prepare them for output. This includes eliminating bookmarks and extra memory that is not used in the rendering process. In addition, it includes synchronization of the renderable structure's internal state with the output schema, compilation of dynamic scripts, loading of external or persistent database-stored files, etc. The returned collection is still fairly abstract in the sense that it is like a musical score, that provides a great deal of leeway for interpretation by the rendering subsystem.

2. Algorithm Pseudocode Listing Function “Parse”.

```
    1. function Parse(locale: string text: string):
ListOfGrammarData
    2. begin
    3. result: ListOfGrammarData :=
CreateListOfGrammarData(locale)
    4. corpus := ExternalParseCorpus(locale, text)
    5. nparas: Integer := corpus.Count
    6. ipara: Integer := 0
    7. while (ipara < nparas) do
    8. begin
    9. paragraph: Paragraph := corpus.Item[ipara]
  10. nsentences: Integer := paragraph.Count
  11. isentence: Integer := 0
  12. while (isentence < nsentences) do
  13. begin
  14. sentence: Sentence :=
paragraph.Item[isentence]
  15. working: GrammarDataElement :=
CreateGrammarDataElement(locale)
  16. working.Index := (isentence + 1)
  17. nwords: Integer := sentence.Vector.Count
  18. iword: Integer := 0
  19. while (iword < nwords) do
  20. begin
  21. word :=
NormalizeAndSpell(sentence.Vector.Item[iword].Text)
  22.
working.Sentence.Add(sentence.Vector.Item[iword])
  23. beginif
  24.
TryToMatchWordOnIgnoreCategory(iword, word, working) or
  25.
TryToMatchWordOnSubjectCategory(iword, word, working) or
  26.
TryToMatchWordOnActionCategory(iword, word, working) or
  27.
TryToMatchWordOnSubjectModifierCategory(iword, word, working) or
  28.
TryToMatchWordOnActionModifierCategory(iword, word, working) or
  29.
TryToMatchWordOnConnectorCategory(iword, word, working)
  30. then continue
  31. end
  32.
working.Words.Add(TaggedWord.Create(iword, word,
ElementType.Dropped))
  33. inc(iword)
  34. end
  35. result.Add(working)
  36. inc(isentence)
  37. end
  38. inc(ipara)
  39. end
  40. Result := result
  41. end;
```

A. Function declared in (1) intended to provide a basic overview of the parsing phase after a text block (corpus) is received from the user.

B. Function “ExternalParseCorpus” in (4) defined as a call to a modular or pluggable natural language processing subsystem and method that may be changed as the technology changes or improves.

C. The loop beginning at (7) iterates over paragraph-level structures returned from the “ExternalParseCorpus” function in (4).

D. The “GrammarDataElement” structure in (15) holds only elements that are found within the database of renderable items. Other grammatical elements are dropped. For example, known words such as “the” do not commonly map to any known renderables. Unknown or unforseen words not supported in the database are dropped, and may be added to an external database table or file of unknown words that are suggested to be added at a later time.

E. The loop beginning at (19) iterates over the words present in the current sentence.

F. The function “NormalizeAndSpell” in line (21) normalizes words according to casing rules, and attempts to correct possible errors due to misspellings. Note: This spell-checking may have already have occurred in the “ExternalParseCorpus” function in (4).

G. Lines (24-29) attempt to match the normalized, part of speech tagged words to renderable categories or ontologies of word items present in the database.

H. Finally, if the word fails to match any known category, it is assigned the “dropped” category, as seen in line (32).

3. Algorithm Pseudocode Listing Function “Partition”.

```
      1. function Partition(paragraph: ListOfGrammarData):
ListOfAssociatedElements
      2. begin
      3. result := ListOfAssociatedElements.Create
      4. m: Integer := paragraph.Count
      5. i: Integer := 0
      6. while (i < m) do
      7. begin
      8. sentence := paragraph.Item[i]
      9. elements := sentence.Elements
      10. n: Integer := elements.Count
      11. associations :=
ListOfAssociatedElements.Create
      12. result.Add(associations)
      13. assoc := nil
      14. j: Integer := 0
      15. while (j < n) do
      16. begin
      17. case elements.Item[j].Type of
      18. ElementType.Subject:
      19. begin
      20. if (assoc <> nil) then break
      21. assoc := AssociatedElements.Create
      22. assoc.Subject :=
(elements.Item[j].Element as Subject)
      23.
assoc.Words.Add(elements.Item[j].Word)
      24. associations.Add(assoc)
      25. continue
      26. end
      27. ElementType.SubjectModifier:
      28. begin
      29. if (assoc <> nil) then goto
ConditionSubjectModifier
      30. assoc := AssociatedElements.Create
      31.
assoc.SubjectModifiers.Add(elements.Item[j].Element as
SubjectModifier)
      32.
assoc.Words.Add(elements.Item[j].Word)
      33. associations.Add(assoc)
      34. continue
      35. end
      36. ElementType.Action:
      37. begin
      38. if (assoc <> nil) then goto
ConditionAction
      39. assoc := AssociatedElements.Create
      40. assoc.Action :=
(elements.Item[j].Element as Action)
      41.
assoc.Words.Add(elements.Item[j].Word)
      42. associations.Add(assoc)
      43. continue
      44. end
      45. ElementType.ActionModifier:
      46. begin
      47. if (assoc <> nil) then goto
ConditionActionModifier
      48. assoc := AssociatedElements.Create
      49.
assoc.ActionModifiers.Add(elements.Item[j].Element as
ActionModifier)
      50.
assoc.Words.Add(elements.Item[j].Word)
      51. associations.Add(assoc)
      52. continue
      53. end
      54. ElementType.Connector:
      55. begin
      56. if (assoc <> nil) then goto
ConditionConnectorLink
      57. assoc := AssociatedElements.Create
      58. assoc.Link :=
AssociationLink.Create
      59. assoc.Link.Connector :=
(elements.Item[j].Element as Connector)
      60.
assoc.Words.Add(elements.Item[j].Word)
      61. assoc.Link.Q :=
ListOfAssociatedElements.Create
      62. assoc.Link.Q.Add(assoc)
      63. associations.Add(assoc)
      64. continue
      65. end
      66. default: continue
      67. end
      68. if (assoc <> nil) and (assoc.Subject =
nil) then
      69. begin
      70. assoc.Subject :=
(elements.Item[j].Element as Subject)
      71. assoc.Words.Add(elements.Item[j].Word)
      72. end
      73. else
      74. if (assoc <> nil) and (assoc.Subject
<> nil) then
      75. begin
      76. assoc := AssociatedElements.Create
      77. assoc.Subject :=
(elements.Item[j].Element as Subject)
      78.
assoc.Words.Add(elements.Item[j].Word)
      79. associations.Add(assoc)
      80. end
      81. continue
      82. ConditionAction:
      83. if (assoc <> nil) then
      84. if (assoc.Action = nil) then
      85. begin
      86. assoc.Action :=
(elements.Item[j].Element as Action)
      87.
assoc.Words.Add(elements.Item[j].Word)
      88. end
      89. else if (assoc.Action <> nil) then
      90. begin
      91. assoc := AssociatedElements.Create
      92. assoc.Action :=
(elements.Item[j].Element as Action)
      93.
assoc.Words.Add(elements.Item[j].Word)
      94. associations.Add(assoc)
      95. end
      96. continue
      97. ConditionSubjectModifier:
      98. if (assoc <> nil) then
      99. begin
    100.
assoc.SubjectModifiers.Add(elements.Item[j].Element as
SubjectModifier)
    101.
assoc.Words.Add(elements.Item[j].Word)
    102. end
    103. continue
    103. ConditionActionModifier:
    104. if (assoc <> nil) then
    105. begin
    106.
assoc.ActionModifiers.Add(elements.Item[j].Element as
ActionModifier)
    107.
assoc.Words.Add(elements.Item[j].Word)
    108. end
    109. continue
    110. ConditionConnectorLink:
    111. if (assoc <> nil) then
    112. begin
    113. assoc.Link :=
AssociationLink.Create
    114. assoc.Link.Connector :=
(elements.Item[j].Element as Connector)
    115.
assoc.Words.Add(elements.Item[j].Word)
    116. assoc.Link.P :=
ListOfAssociatedElements.Create
    117. assoc.Link.P.Add(assoc)
    118. assoc := nil
    119. end
    120. inc(j)
    121. end
    122. inc(i)
    123. end
    124. Result := result
    125. end;
```

A. Function declared in (1) intended to provide a some insight into the inner workings, for reference purposes only, of the operation in the function “Connect” in the pseudocode listing #1-5, “Process”.

B. The “Partition” algorithm proceeds by determining, via grammatical structure, and basic logic, among other rules, to which list of associations each word, and consequent set of media elements belong.

C. “Partition” proceeds by iterating through the grammatical data, and first ensuring that each set of associated elements has at minimum: a., a subject (e.g. noun), and b., a verb. Lacunae, or missing elements are filled in later by the parent “Process” algorithm.

We claim:

1. A system and method are used to receive a textual composition, via a user interface, or batch mode interface, and classify words, word-pairs, and/or phrases of said textual composition's component sentence(s) and/or paragraph(s) into lexemes and/or parts of speech, and interpret said lexemes and/or parts of speech to construct playable structures which are logical units of graphics, sounds, animations thereof, and modifications thereof, where said playable structures may be combined to create a single scene, or single scenes, and may be played in order of their occurrence in the composition as a sequential and timed artistic multimedia representation of said composition, and output, in real-time or stored in memory for later output, via a monitor, projector, speakers, and/or other output devices.

2. The system in claim 1 permits a user to select a preferred input language and word-to-multimedia-mapping database.

3. The textual composition in claim 1 may be a written or spoken narrative, theatrical script, dialogue, song lyrics, or other natural language text of any total number of words, and the textual composition may be written or spoken in any language supported by the system in claim 1.

4. The interface in claim 1 may receive a textual composition, or other form of natural language text from the user, and in the preferred embodiment this may include, but is not limited to: a text input graphical interface box, a file loading selection dialogue, an automatic speech recognition system, batch loading, or any other convenient means of acquiring textual input.

5. The system in claim 1 stores a plurality of formalized rules in computer memory describing a punctuation standard and the grammatical model of one or more natural languages, and the method and algorithm in claim 1 utilizes these to tokenize the textual composition into lexemes, common words, word-pairs, and/or phrase units, based upon the punctuation and grammatical rules and/or models stored in the system in claim 1.

6. The textual composition in claim 1 is parsed into paragraphs, sentences, and individual words, word-pairs, and/or phrases and stored in the system in order of occurrence in the composition.

7. The method in claim 1 is used to process each paragraph and/or sentence in claim 1 to create either single or multiple playable structure(s) using words and/or word-pairs and/or phrases in the textual composition in claim 1, by identifying lexemes and/or parts of speech via a predefined, and user-interactive word-to-multimedia-mapping database.

8. A playable structure in claim 1 is a logical unit comprised of at least a single referenced noun and a single referenced verb, and a playable structure in claim 1 may also be comprised of multiple referenced nouns, multiple referenced verbs, as well as multiple referenced adjectives and referenced adverbs and other identifying words(s) such as referenced connector words or proper names.

9. Referenced nouns in claim 8 are grouped with referenced verbs from the sentence and/or paragraph, while referenced adverbs in claim 8 may modify motions, x, y, z coordinate locations, velocities, and/or directions, and/or other kinematics in the playable structure, while referenced adjectives in claim 8 may modify graphical qualities such as, but not necessarily limited to color, brightness, size, type of graphic in the playable structure, and referenced connectors in claim 9 are words identified by the method in claim 1 and word database that are used to relate multiple playable structures to each other in a scene.

10. The playable structure in claim 1 may be comprised of referenced nouns, verbs, adverbs, adjectives, connectors, and other parts of speech, and the playable structure in claim 1 is a data structure in computer memory consisting of graphics, animations, sounds, kinematics, and/or motions of said graphics.

11. Nouns in claim 10 are represented in the playable structure by graphics, animations, graphics modifications, color, dimensions, and/or sounds, and verbs in claim 10 are represented in the playable structure by motions, x,y, and/or z user interface coordinate locations, kinematics, velocities, directions of movement on the user interface, and/or sounds, and may also determine the type of graphic used by the noun, and advanced physical properties and constraints such as inverse kinematics.

12. The method in claim 1, if no referenced verb is identifiable in the paragraph or sentence, may assign a default reference verb to the playable structure, and the method in claim 1, if no noun is identifiable in the paragraph or sentence, may assign a default reference noun to the playable structure, while unclassifiable words are not included by the method in claim 1 in the playable structure and are logged for future reference, and misspelled words in the composition may be corrected by a spelling correction program.

13. Sounds in claim 1 may be digitized audio recordings or synthesized sound waves, as well as other computerized sound file formats stored in a computer database or file system or generated dynamically based upon scripting and parameters of the system state.

14. Graphics in claim 1 may be stored as raster or vector images, or animations, and may be stored in a database or computer memory system, or generated dynamically based upon the scripting and parameters of system state.

15. Each playable structure in claim 1 is presented via the user interface(s) as part of a scene, either alone, or combined with other playable structures by the method of the algorithm in claim 1, and may appear in order or sequence of the original composition, via the user interface.

16. The method of artistic multimedia representation in claim 1 may include timing constraints, sounds, interface coordinates, animations, graphics, and visual or audible modifications to said sounds, animations, graphics, and interface coordinates.

17. Scenes in claim 1 are played on the user interface for a determined and/or randomized time and scenes in claim 1 may also be looped to play continuously on the user interface until stopped by the user, while the determined time in claim 1 is determined by the algorithm in claim 1 by sentence length and/or a user time value, and/or or randomized value, and timing may also be synchronized to an external multimedia clock system for the purposes of synchronizing the artistic multimedia representation to another media event, such as a DJ (disc jockey) or musical band, script review, or singing event.

18. A scene in claim 1, may be comprised of single or related multiple playable structures, and is manifested in an artistic multimedia representation of single or multiple sentences or paragraphs in the composition and the timed multimedia representation of the composition in claim 1.

19. The system in claim 1 may pass randomized variables, created by a random number generator, to parameters and timing of the playable structure and/or scenes to provide a more natural look and feel of the output multimedia representation.
